(19) United States
(12) Patent Application Publication
(10) Pub. No.: US 2026/0168606 A1
(43) Pub. Date: Jun. 18, 2026

(54) Connecting Assembly

(71) Applicant: Illinois Tool Works Inc., Glenview, IL (US)

(72) Inventor: Cong Cao, Shanghai (CN)

(21) Appl. No.: 19/419,431

(22) Filed: Dec. 15, 2025

(30) Foreign Application Priority Data
Dec. 16, 2024 (CN) 202411853984.8
Dec. 8, 2025 (CN) 202511843835.8

(51) Int. Cl. F16L 37/091

(52) U.S. Cl. CPC F16L 37/0915

(57) ABSTRACT

The present disclosure provides a connecting assembly having an axis and including a retaining member and an insert. The retaining member includes a base portion and a plurality of retaining arms, the base portion defines a receiving passage, and the plurality of retaining arms are connected to the base portion and deflectable relative to the base portion toward or away from the axis. The insert is provided with a first locking portion and a second locking portion. The insert is received in the receiving passage of the retaining member and is movable relative to the retaining member along the axis in a first direction to switch the connecting assembly from a pre-assembled state to an assembled state. At least one of the plurality of retaining arms is configured to engage with the first locking portion when the connecting assembly is in the pre-assembled state, and at least one of the plurality of retaining arms is configured to engage with the second locking portion when the connecting assembly is in the assembled state.

### RELATED APPLICATIONS

The present application claims the benefit of Chinese Patent Application Nos. 202411853984.8, filed Dec. 16, 2024, and 202511843835.8, filed Dec. 8, 2025, each titled “Connecting Assembly,” the contents of which are hereby incorporated by reference.

### TECHNICAL FIELD

The present disclosure relates to a connecting assembly, and in particular, relates to a connecting assembly for connecting pipes to a part.

### BACKGROUND

In one disclosure scenario, a connector is used to connect pipes on both sides of a part (e.g., a plate). To achieve this, the connector needs to pass through a hole in the part, connect to the pipes on both sides of the part, and itself be connected to the part, in order to maintain the connected state of the pipes and the connector.

### SUMMARY OF THE DISCLOSURE

The present disclosure generally relates to a connecting assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is a perspective view of a connecting assembly according to an embodiment of the present disclosure.

FIG. 1B is an exploded view of the connecting assembly shown in FIG. 1A.

FIG. 2A is a front view of a retaining member of the connecting assembly shown in FIG. 1A.

FIG. 2B is a cross-sectional view of the retaining member shown in FIG. 2A taken along line A-A.

FIG. 2C is a cross-sectional view of the retaining member shown in FIG. 2A taken along line B-B.

FIG. 3A is a perspective view of an insert of the connecting assembly shown in FIG. 1A.

FIG. 3B is a cross-sectional view of the insert shown in FIG. 3A taken along line C-C.

FIG. 3C is a cross-sectional view of the insert shown in FIG. 3A taken along line D-D.

FIG. 4A is a cross-sectional view of the connecting assembly shown in FIG. 1A taken along line A-A in FIG. 2A when in a pre-assembled state.

FIG. 4B is a cross-sectional view of the connecting assembly shown in FIG. 1A taken along line B-B in FIG. 2A when in the pre-assembled state.

FIG. 5A is a cross-sectional view of the connecting assembly shown in FIG. 1A taken along line A-A in FIG. 2A when in a first state during an installation process.

FIG. 5B is a cross-sectional view of the connecting assembly shown in FIG. 1A taken along line B-B in FIG. 2A when in a first state during the installation process.

FIG. 6A is a cross-sectional view of the connecting assembly shown in FIG. 1A taken along line A-A in FIG. 2A when in a second state during the installation process.

FIG. 6B is a cross-sectional view of the connecting assembly shown in FIG. 1A taken along line B-B in FIG. 2A when in a second state during the installation process.

FIG. 7A is a cross-sectional view of the connecting assembly shown in FIG. 1A taken along line A-A in FIG. 2A when in an assembled state.

FIG. 7B is a cross-sectional view of the connecting assembly shown in FIG. 1A taken along line B-B in FIG. 2A when in the assembled state.

FIG. 8 is a perspective view of a connecting assembly according to another embodiment of the present disclosure.

FIG. 9A is a perspective view of a retaining member of the connecting assembly shown in FIG. 8.

FIG. 9B is a side view of the retaining member shown in FIG. 9A.

FIG. 10A is a perspective view of an insert of the connecting assembly shown in FIG. 8.

FIG. 10B is an axial cross-sectional view of the insert shown in FIG. 10A.

FIG. 11A is an axial cross-sectional view of the connecting assembly shown in FIG. 8 when in a pre-assembled state.

FIG. 11B is an axial cross-sectional view of the connecting assembly shown in FIG. 8 when in a state during an installation process.

FIG. 11C is an axial cross-sectional view of the connecting assembly shown in FIG. 8 when in an assembled state.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

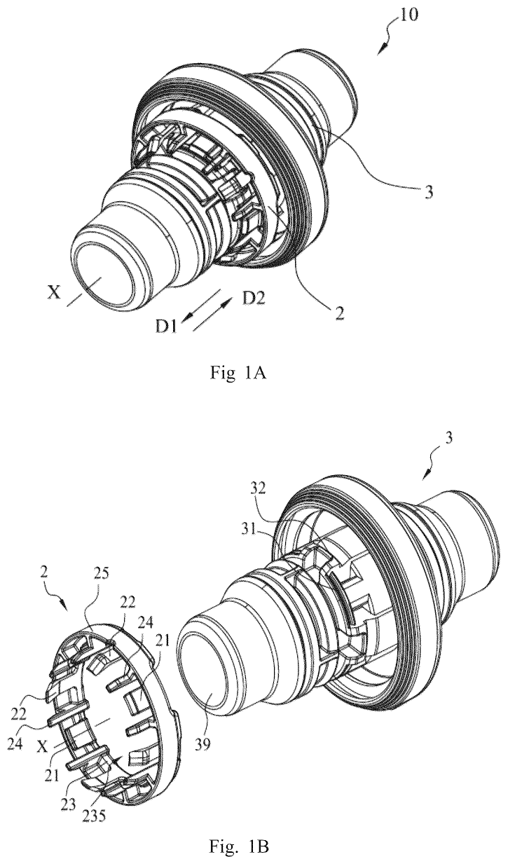

The “first direction” in the present disclosure refers to the leftward direction along the axis X, as shown by arrow D1 in FIG. 1A, and the “second direction” in the present disclosure refers to the rightward direction along the axis X, as shown by arrow D2 in FIG. 1A. Additionally, in the present disclosure, “a plurality of” means at least two, for example, two, three, or more, unless explicitly and specifically defined otherwise.

Through in-depth research, it has been discovered that in the prior art, existing connectors are connected to a part via means such as threading. The installation process of such connectors is cumbersome, requires additional installation tools, and demands sufficient operating space for operators.

The present disclosure provides a connecting assembly having an axis and including a retaining member and an insert. The retaining member includes a base portion and a plurality of retaining arms, the base portion defines a receiving passage, and the plurality of retaining arms are connected to the base portion and deflectable relative to the base portion toward or away from the axis. The insert is provided with a first locking portion and a second locking portion. The insert is received in the receiving passage of the retaining member and is movable relative to the retaining member along the axis in a first direction to switch the connecting assembly from a pre-assembled state to an assembled state. At least one of the plurality of retaining arms is configured to engage with the first locking portion when the connecting assembly is in the pre-assembled state, and at least one of the plurality of retaining arms is configured to engage with the second locking portion when the connecting assembly is in the assembled state.

In some embodiments, the plurality of retaining arms include at least one first retaining arm and at least one second retaining arm. The at least one first retaining arm is configured to engage with the first locking portion when the connecting assembly is in the pre-assembled state, and to be driven by the insert during switching of the connecting assembly from the pre-assembled state to the assembled state to deflect away from the axis so as to disengage from the first locking portion. The at least one second retaining arm is configured to engage with the second locking portion when the insert is in the assembled state.

In some embodiments, the first locking portion includes at least one first locking groove, and the first retaining arm includes a first locking head at a distal end thereof. The first locking groove is configured to at least partially receive the first locking head and restrict movement of the insert relative to the retaining member in the first direction and a second direction opposite to the first direction.

In some embodiments, the first locking groove includes a first rear side wall, and a portion of the first rear side wall that is farther from the axis extends obliquely away from the axis in the second direction. The first rear side wall is configured to drive the first retaining arm to deflect away from the axis during switching of the connecting assembly from the pre-assembled state to the assembled state.

In some embodiments, the second locking portion includes at least one second locking groove, and the second retaining arm includes a second locking head at a distal end thereof. The second locking portion is configured to cooperate with the second locking head to restrict movement of the insert relative to the retaining member in a second direction opposite to the first direction when the connecting assembly is in the assembled state.

In some embodiments, the second retaining arm further includes a third locking portion provided on an outer side thereof facing away from the axis, and the third locking portion is a locking protrusion. The third locking portion is configured to restrict the connecting assembly from moving away from its installation position in the second direction when the connecting assembly is in the assembled state.

In some embodiments, the second retaining arm includes an arm body and a wedge portion connected to the arm body, an outer surface of the wedge portion protrudes outward relative to an outer surface of the arm body to form the third locking portion, and a distal end of the wedge portion forms the second locking head. In an undeflected state of the second retaining arm, the arm body extends substantially parallel to the axis, and an inner surface of the wedge portion extends obliquely toward the axis in the first direction.

In some embodiments, the retaining member is further provided with a first blocking portion connected to the base portion and configured to restrict movement of the retaining member relative to its installation position in the first direction. The insert is further provided with a second blocking portion configured to restrict the connecting assembly from moving relative to its installation position in the first direction when the connecting assembly is in the assembled state.

In some embodiments, the insert is further provided with a sealing portion, the sealing portion is at least partially located on a side of the second blocking portion facing the first locking portion and the second locking portion, is connected to the second blocking portion, and extends circumferentially.

In some embodiments, the retaining member further includes a plurality of guiding arms connected to the base portion and uniformly arranged around the axis. The plurality of guiding arms are configured to guide the connecting assembly in the pre-assembled state to be inserted into its installation position.

In some embodiments, each of the retaining arms is configured to engage with the first locking portion when the connecting assembly is in the pre-assembled state, to be driven by the insert during switching of the connecting assembly from the pre-assembled state to the assembled state to deflect away from the axis so as to disengage from the first locking portion, and to engage with the second locking portion when the connecting assembly is in the assembled state.

In some embodiments, the retaining arm includes a locking head at a distal end thereof, and the retaining arm engages with the first locking portion or the second locking portion via the locking head.

In some embodiments, the first locking portion includes a first locking groove. The first locking groove is configured to at least partially receive the locking head to restrict movement of the insert relative to the retaining member in the first direction and a second direction opposite to the first direction.

In some embodiments, the first locking groove includes a first rear side wall, the first rear side wall extends obliquely away from the axis in the second direction. The first rear side wall is configured to drive the retaining arm to deflect away from the axis during switching of the connecting assembly from the pre-assembled state to the assembled state.

In some embodiments, an inner surface of the retaining arm near the locking head forms a driven surface, and the driven surface extends obliquely toward the axis in the first direction so as to be driven by the first rear side wall.

In some embodiments, the second locking portion includes a second locking projection. The second locking portion is configured to cooperate with the locking head to restrict movement of the insert relative to the retaining member in a second direction opposite to the first direction when the connecting assembly is in the assembled state.

In some embodiments, when the connecting assembly is in the assembled state, the retaining arms are deflected away from the axis, so that the retaining arms restrict the connecting assembly from moving away from its installation position in a second direction opposite to the first direction.

In some embodiments, the retaining member is further provided with a first blocking portion connected to the base portion and configured to restrict movement of the retaining member relative to its installation position in the first direction. The insert is further provided with a second blocking portion configured to restrict the connecting assembly from moving relative to its installation position in the first direction when the connecting assembly is in the assembled state.

In some embodiments, the retaining member further includes a first sealing portion and a second sealing portion. The first sealing portion is at least partially located on a side of the first blocking portion facing the retaining arms, is connected to the first blocking portion, and extends circumferentially. The second sealing portion is at least partially located on a side of the first blocking portion facing away from the retaining arms, is connected to the first blocking portion, and extends circumferentially.

In some embodiments, the retaining member further includes isolation portions disposed on outer surfaces of the retaining arms facing away from the axis. The insert and the retaining member are made of a first material, the isolation portions are made of a second material, and an elastic modulus of the first material is greater than an elastic modulus of the second material.

Compared with the prior art, the installation process of the connecting assembly of the present disclosure to a part is simple to operate and does not require additional installation tools, making it particularly suitable for operations in narrow spaces or with obstructed vision.

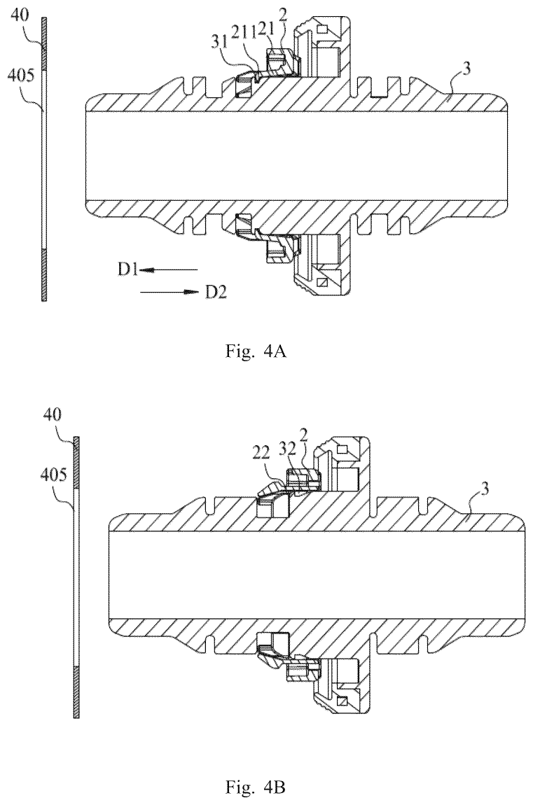

FIGS. 1A to 7B show a connecting assembly 10 according to an embodiment of the present disclosure. The connecting assembly 10 can be connected to a part 40 having a hole 405 (as shown in FIG. 4A). In one application, pipes on both sides of the part 40 achieve fluid connection through the connecting assembly 10.

FIGS. 1A and 1B are a perspective view and an exploded view of the connecting assembly 10, respectively. As shown in FIGS. 1A and 1B, the connecting assembly 10 includes a retaining member 2 and an insert 3, and has an axis X. The retaining member 2 is sleeved on the insert 3. The connecting assembly 10 has a pre-assembled state and an assembled state. In the pre-assembled state, the retaining member 2 and the insert 3 are connected to each other and held together, and movement of the insert 3 relative to the retaining member 2 along the axis X in a first direction D1 (i.e., the leftward direction in FIG. 1A, as indicated by arrow D1) and an opposite second direction D2 (i.e., the rightward direction in FIG. 1A, as indicated by arrow D2) is restricted. Maintaining the retaining member 2 and the insert 2 in the pre-assembled state facilitates storage and transportation of the connecting assembly 10, and installation of the connecting assembly 10 on the part 40 (as shown in FIG. 4A), among other things. In the assembled state, the connecting assembly 10 is installed in place at the installation position on the part 40 (as shown in FIG. 4A) and is retained at the installation position. The switching of the connecting assembly 10 from the pre-assembled state to the assembled state is achieved by movement of the insert 3 relative to the retaining member 2 in the first direction D1. FIG. 1A shows the connecting assembly 10 in its pre-assembled state.

Still referring to FIGS. 1A and 1B, the retaining member 2 includes a base portion 23 and retaining arms, and the retaining arms include first retaining arms 21 and second retaining arms 22. The base portion 23 defines a receiving passage 235. The first retaining arms 21 and the second retaining arms 22 are connected to the base portion 23 and are deflectable relative to the base portion 23 toward or away from the axis X. The first retaining arms 21 and the second retaining arms 22 are connected to the same side of the base portion 23 and extend generally along the axis X.

The insert 3 is generally tubular, defining an axial passage 39 for achieving fluid connection of pipes. The insert 3 is provided with a first locking portion 31 and a second locking portion 32, and the first locking portion 31 and the second locking portion 32 are located at different axial positions on the insert 3. The insert 3 is received in the receiving passage 235 of the base portion 23 of the retaining member 2 and is movable relative to the retaining member 2 along the axis X in the first direction D1 to switch the connecting assembly 10 from the pre-assembled state to the assembled state. In the pre-assembled state, the first retaining arms 21 of the retaining member 2 engage with the first locking portion 31 of the insert 3 to connect and hold the retaining member 2 and the insert 3 together. In the assembled state, the second retaining arms 22 of the retaining member 2 engage with the second locking portion 32 of the insert 3 so that the connecting assembly 10 can be installed in place at the installation position on the part 40 (as shown in FIG. 4A).

The retaining member 2 further includes guiding arms 24. The guiding arms 24 are connected at their proximal ends to the base portion 23 and extend generally along the axis X for guiding the connecting assembly 10 in the pre-assembled state to be inserted into the hole 405 of the part 40 (as shown in FIG. 4A). For this purpose, the outer surfaces of the guiding arms 24 near their distal ends are configured as tapered surfaces converging toward the distal ends.

In the illustrated embodiment, the number of the first retaining arms 21 is four, and these four first retaining arms 21 are symmetrically arranged relative to the axis X. The number of the second retaining arms 22 is four, and these four second retaining arms 22 are symmetrically arranged relative to the axis X. The number of the guiding arms 24 is also four, and these four guiding arms 24 are symmetrically arranged relative to the axis X. Furthermore, the first retaining arms 21, the second retaining arms 22, and the guiding arms 24 are arranged spaced apart from each other in the circumferential direction of the base portion 23. In other embodiments, the numbers of the first retaining arms 21, the second retaining arms 22, and the guiding arms 24 are not limited to those shown in the figures.

As shown in FIG. 1B, the retaining member 2 further includes a first blocking portion 25. The first blocking portion 25 is connected to the base portion 23 and is arranged on the outer side of the base portion 23. It is used to restrict movement of the retaining member 2 relative to the part 40 in the first direction D1 after the connecting assembly 10 is inserted into the hole 405 of the part 40 (as shown in FIG. 4A). The first blocking portion 25 is generally ring-shaped, extending around the base portion 23.

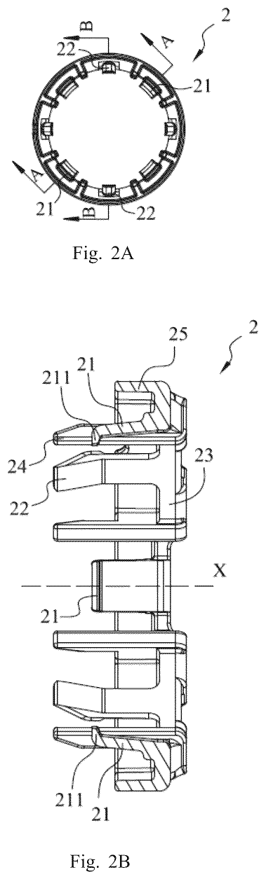

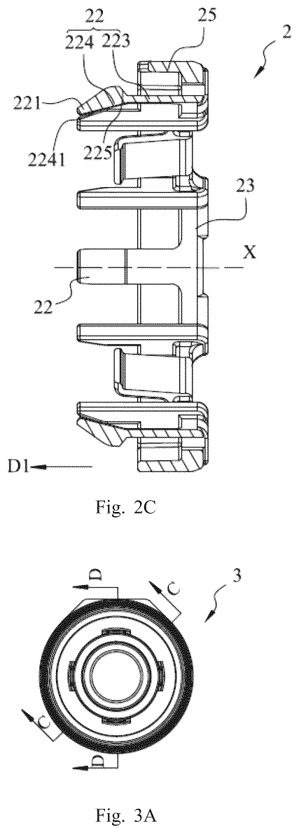

FIGS. 2A-2C show the specific structure of the retaining member 2. FIG. 2A is a front view of the retaining member 2, FIG. 2B is a cross-sectional view of the retaining member 2 taken along line A-A in FIG. 2A, and FIG. 2C is a cross-sectional view of the retaining member 2 taken along line B-B in FIG. 2A. As shown in FIG. 2A, line A-A passes through the first retaining arm 21, and line B-B passes through the second retaining arm 22.

As shown in FIG. 2B, the first retaining arm 21 is connected at its proximal end to the base portion 23 and includes a first locking head 211 at its distal end. The first locking head 211 is used to engage with the first locking portion 31 on the insert 3. In the illustrated embodiment, the first locking head 211 is formed by inwardly bending the distal end of the first retaining arm 21. In an undeflected state of the first retaining arm 21, the first retaining arm 21 extends substantially parallel to the axis X. The length of the first retaining arm 21 along the axis X is less than the lengths of the second retaining arm 22 and the guiding arm 24 along the X-axis.

As shown in FIG. 2C, the second retaining arm 22 is connected at its proximal end to the base portion 23. The second retaining arm 22 includes a second locking head 221 at its distal end, and a third locking portion 225 at its outer side facing away from the axis X. The second locking head 221 is used to engage with the second locking portion 32 on the insert 3. The third locking portion 225 is used to restrict the connecting assembly 10 from moving out of its installation position in the second direction D2 when the connecting assembly 10 is in the assembled state.

In the illustrated embodiment, the second retaining arm 22 includes an arm body 223 connected to the base portion 23 and a wedge portion 224 connected to the arm body 223. The distal end of the wedge portion 224 forms the second locking head 221. The outer surface of the wedge portion 224 protrudes outward relative to the outer surface of the arm body 223 to form the third locking portion 225. In an undeflected state of the second retaining arm 22, the arm body 223 extends substantially parallel to the axis X, and the inner surface 2241 of the wedge portion 224 extends obliquely toward the axis X in the first direction D1. Therefore, the second locking head 221 is closer to the axis X than the arm body 223.

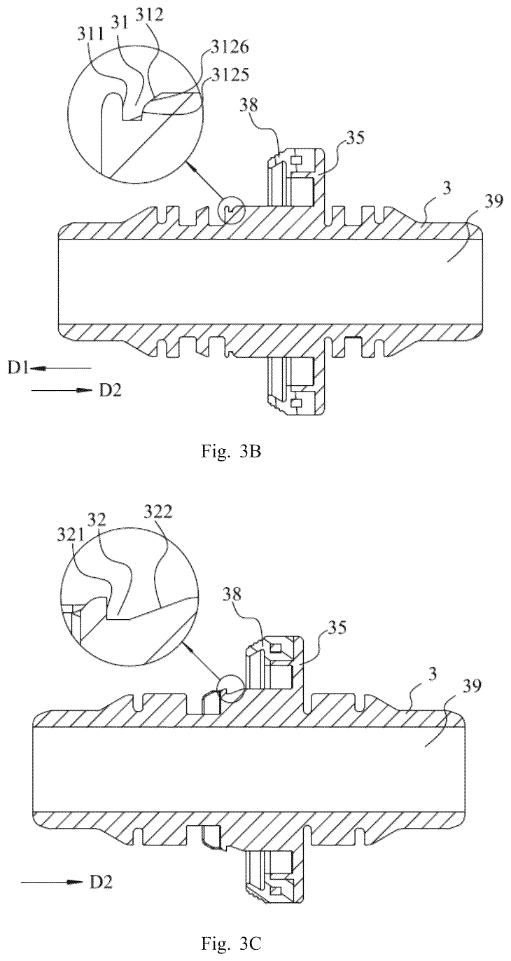

FIGS. 3A-3C show the specific structure of the insert 3. FIG. 3A is a front view of the insert 3, FIG. 3B is a cross-sectional view of the insert 3 taken along line C-C in FIG. 3A, and FIG. 3C is a cross-sectional view of the insert 3 taken along line D-D in FIG. 3A. Line C-C passes through the first locking portion 31 (blocked from view in FIG. 3A), and line D-D passes through the second locking portion 32 (blocked from view in FIG. 3A). Line C-C is substantially the same as line A-A in FIG. 2A, and line D-D is substantially the same as line B-B in FIG. 2A.

As shown in FIG. 3B, the axial passage 39 of the insert 3 extends axially through the insert 3. The first locking portion 31 includes a plurality of first locking grooves (see FIG. 1B), the number of which is the same as the number of the first retaining arms 21, and they are arranged spaced apart circumferentially. Each first locking groove is for receiving the first locking head 211 of a corresponding first retaining arm 21. The first locking groove includes a first front side wall 311 and a first rear side wall 312. When the first locking head 211 is received in the first locking groove, the first front side wall 311 restricts movement of the insert 3 relative to the retaining member 2 in the second direction D2, and the first rear side wall 312 restricts movement of the insert 3 relative to the retaining member 2 in the first direction D1. Furthermore, the first rear side wall 312 drives the first retaining arm 21 to deflect away from the axis X during the process of switching the connecting assembly from the pre-assembled state to the assembled state.

For this purpose, the first front side wall 311 extends substantially perpendicular to the axis X. A wall part 3125 of the first rear side wall 312 that is closer to the axis X extends substantially perpendicular to the axis X. A wall part 3126 of the first rear side wall 312 that is farther from the axis X extends obliquely away from the axis X in the second direction D2. Thus, the first locking portion 31 holds the insert 3 and the retaining member 2 in the pre-assembled state via the first front side wall 311 and the wall part 3125 of the first rear side wall 312. The inclined configuration of the wall part 3126 of the first rear side wall 312 facilitates the separation of the first retaining arm 21 from the first locking portion 31 of the insert 3 when the insert 3 in the pre-assembled state is subjected to a pushing or pressing force in the first direction D1, allowing the connecting assembly to switch from the pre-assembled state to the assembled state.

As shown in FIG. 3C, the second locking portion 32 of the insert 3 includes a plurality of second locking grooves (see FIG. 1B), the number of which is the same as the number of the second retaining arms 22, and they are arranged spaced apart circumferentially. The second locking groove includes a second front side wall 321 and a second rear side wall 322. Each second locking groove is for receiving the second locking head 221 of a corresponding second retaining arm 22. The second front side wall 321 extends substantially perpendicular to the axis X, and the second rear side wall 322 extends obliquely relative to the axis X. Therefore, when the second locking head 221 is received in the second locking groove, the second front side wall 321 restricts movement of the insert 3 relative to the retaining member 2 in the second direction D2, and the second rear side wall 322 conforms to the inner surface 2241 of the wedge portion 224 of the second retaining arm 22.

As shown in FIGS. 3B and 3C, the insert 3 further includes a second blocking portion 35 on its outer surface. The second blocking portion 35 is used to restrict the connecting assembly 10 from moving relative to its installation position in the first direction D1 when the connecting assembly 10 is in the assembled state. In some embodiments, the second blocking portion 35 extends around the insert 3 to form an annular plate shape. The insert 3 further includes a sealing portion 38. The sealing portion 38 is at least partially located on a side of the second blocking portion 35 facing the first locking portion 31 and the second locking portion 32. It is connected to the blocking portion 35 and extends circumferentially. In some embodiments, the sealing portion 38 is integrally injection molded on the blocking portion 35.

FIGS. 4A-7B show the cooperation between the retaining member 2 and the insert 3 when the connecting assembly 10 is in the pre-assembled state, in the assembled state, and during the installation process switching from the pre-assembled state to the assembled state. FIGS. 4A, 5A, 6A, and 7A show axial cross-sectional views passing through the first retaining arms 21 of the retaining member 2 and the first locking portion 31 of the insert 3. FIGS. 4B, 5B, 6B, and 7B show axial cross-sectional views passing through the second retaining arms 22 of the retaining member 2 and the second locking portion 32 of the insert 3.

As shown in FIGS. 4A and 4B, when the connecting assembly 10 is in the pre-assembled state, the insert 3 is received by the retaining member 2. The first retaining arms 21 of the retaining member 2 engage with the first locking portion 31 of the insert 3 via their first locking heads 211, but the second retaining arms 22 of the retaining member 2 are separated from the second locking portion 32 of the insert 3. The first locking heads 211 of the first retaining arms 21 are received in the first locking portion 31. Thus, the insert 3 is restricted by the retaining member 2 from moving in the first direction D1 and the second direction D2. When the connecting assembly 10 is in the pre-assembled state, it has not yet been inserted into the hole 405 of the part 40.

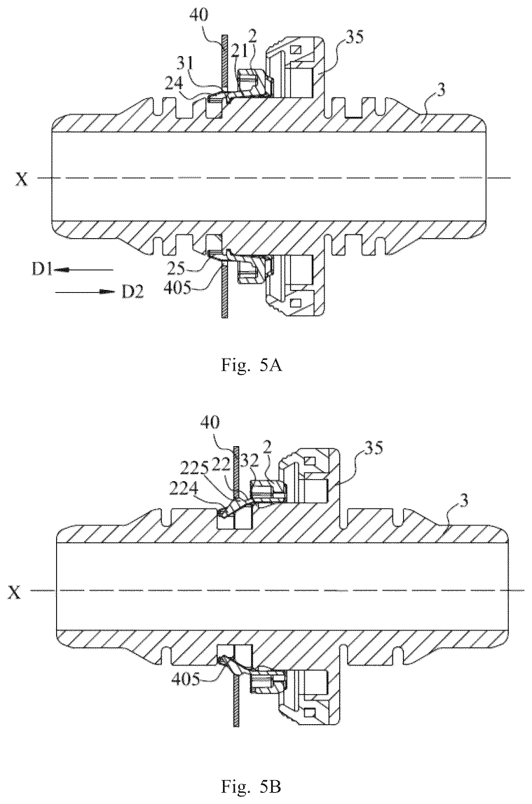

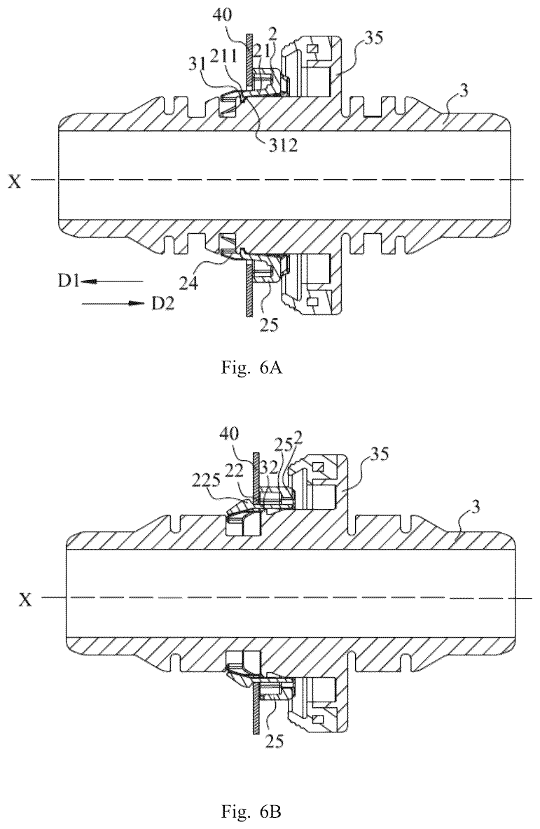

FIGS. 5A and 5B show the connecting assembly in a first state during the installation process, and FIGS. 6A and 6B show the connecting assembly in a second state during the installation process. As shown in FIGS. 5A and 5B, when a pushing or pressing force in the first direction D1 is applied to the connecting assembly 10 in the pre-assembled state to insert it into the hole 405 of the part 40, the wedge portions 224 of the second retaining arms 22 of the retaining member 2 gradually extend into the hole 405 and are pressed by the edge of the hole 405, causing the second retaining arms 22 to deflect toward the axis X until the third locking portions 225 on the second retaining arms 22 pass through the hole 405. After the third locking portions 225 pass through the hole 405, the second retaining arms 22 no longer deflect toward the axis X and therefore return to their initial positions, as shown in FIGS. 6A and 6B. During the process of inserting the connecting assembly 10 in the pre-assembled state into the hole 405 of the part 40, the guiding arms 24 of the retaining member 2 guide the connecting assembly 10 to be centrally inserted into the hole 405, and the first retaining arms 21 of the retaining member 2 remain engaged with the first locking portion 31 of the insert 3.

As shown in FIGS. 6A and 6B, after the third locking portions 225 on the second retaining arms 22 pass through the hole 405, the first blocking portion 25 of the retaining member 2 abuts the rear side of the part 40, thus restricting the retaining member 2 from continuing to move in the first direction D1. Moreover, the third locking portions 225 abut the front side of the part 40, thus restricting the retaining member 2 from moving in the second direction D2. Thus, in the state shown in FIGS. 6A and 6B, the retaining member 2 is retained on the part 40 to allow the insert 3 to move relative to the retaining member 2 in the first direction D1.

In the states shown in FIGS. 5A and 5B, and FIGS. 6A and 6B, the second retaining arms 22 of the retaining member 2 are still separated from the second locking portion 32 of the insert 3.

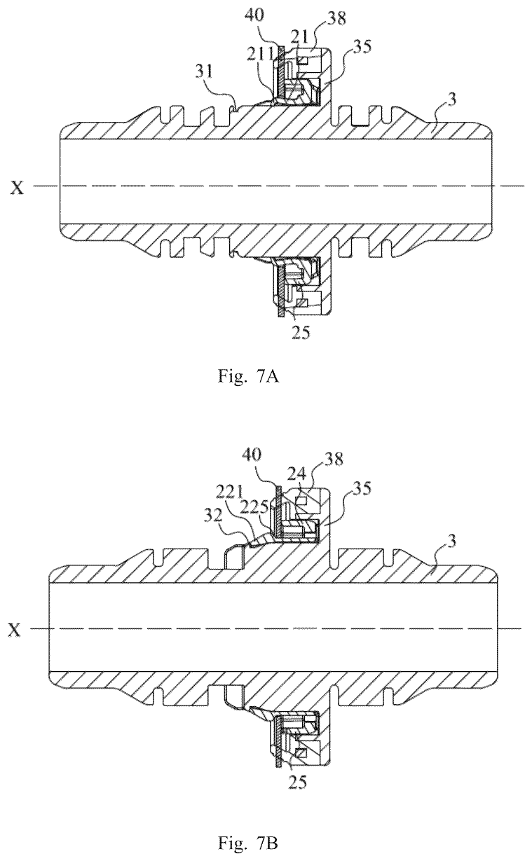

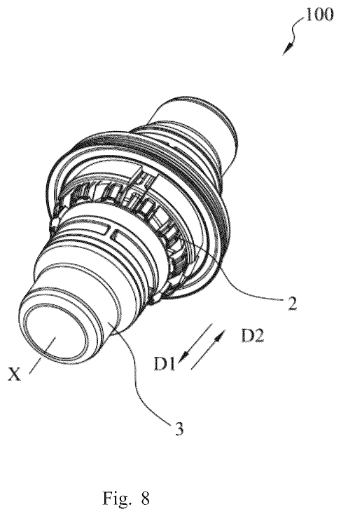

When a pushing or pressing force in the first direction D1 is applied to the insert 3 of the connecting assembly 10 in the state shown in FIGS. 6A and 6B, the first rear side wall 312 of the first locking portion 31 of the insert 3 drives the first retaining arms 21 to deflect away from the axis X, causing the first locking heads 211 of the first retaining arms 21 to separate from the first locking portion 31. Thus, the insert 3 is released from the retaining member 2. The insert 3 moves relative to the retaining member 2 in the first direction D1 under the pushing force, enabling the connecting assembly 10 to be switched to the assembled state shown in FIGS. 7A and 7B.

As shown in FIGS. 7A and 7B, when the connecting assembly 10 is in the assembled state, it is installed in place in the hole 405 of the part 40 and is retained at its installation position. The second locking heads 221 of the second retaining arms 22 engage with the second locking portion 32 of the insert 3 to restrict movement of the insert 3 relative to the retaining member 2 in the second direction D2. The second blocking portion 35 of the insert 3 abuts the part 40 via the sealing portion 38 to restrict movement of the insert 3 relative to the part 40 in the first direction D1. The retaining member 2 is restricted from moving relative to the part 40 in the first direction D1 and the second direction D2 by the cooperation of the third locking portion 224 and the first blocking portion 25 with the part 40. In the assembled state shown in FIGS. 7A and 7B, the first locking heads 211 of the first retaining arms 21 are separated from the first locking portion 31.

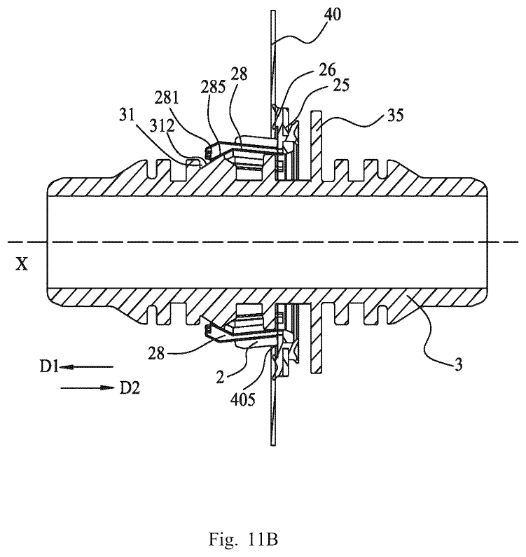

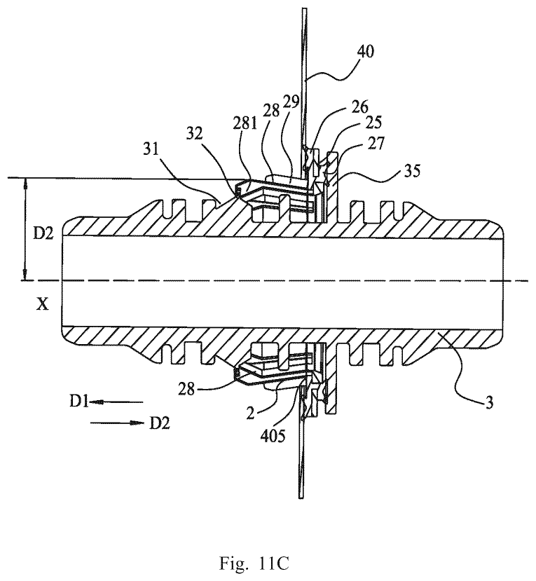

FIGS. 8 to 11C show a connecting assembly 100 according to another embodiment of the present disclosure. The connecting assembly 100 shown in FIGS. 8 to 11C is structurally similar to the connecting assembly 10 shown in FIGS. 1A to 7B, also including a retaining member 2 and an insert 3. The retaining member 2 also has retaining arms, the insert 3 also has a first locking portion 31 and a second locking portion 32, and the connecting assembly 100 also has a pre-assembled state and an assembled state. In the pre-assembled state, the retaining member 2 and the insert 3 are connected to each other and held together. In the assembled state, the connecting assembly 100 is installed in place at the installation position on the part 40 (as shown in FIGS. 11A-11C) and is retained at the installation position. The difference between the connecting assembly 100 and the connecting assembly 10 lies in that the retaining member 2 of the connecting assembly 100 has only one type of retaining arms. The retaining arms engage with the first locking portion 31 of the insert 3 in the pre-assembled state. During the process of switching the connecting assembly 100 from the pre-assembled state to the assembled state, the retaining arms separate from the first locking portion 31 and then engage with the second locking portion 32 in the assembled state.

FIG. 8 is a perspective view of the connecting assembly 100. As shown in FIG. 8, the connecting assembly 100 includes a retaining member 2 and an insert 3, and has an axis X. The retaining member 2 is sleeved on the insert 3.

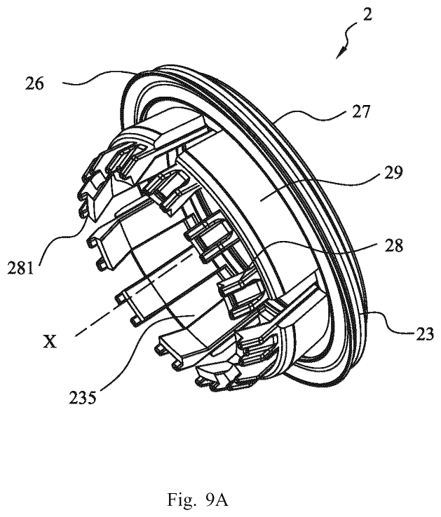

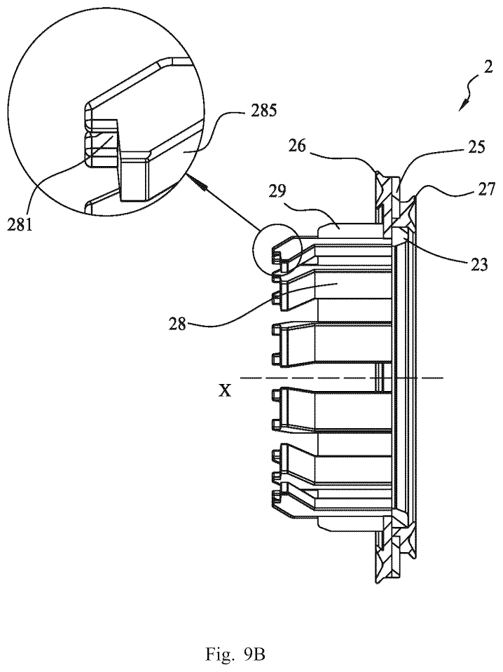

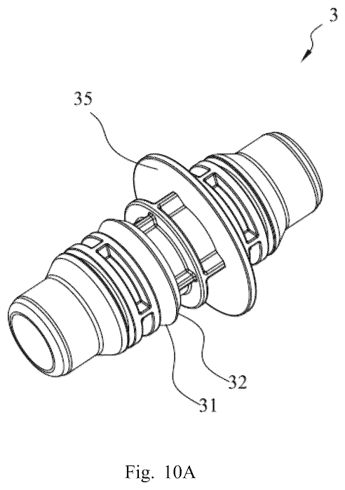

FIGS. 9A and 9B are a perspective view and a side view of the retaining member 2, respectively. As shown in FIGS. 9A and 9B, the retaining member 2 includes a base portion 23 and a plurality of retaining arms 28. The base portion 23 defines a receiving passage 235. The retaining arms 28 are connected to the base portion 23 and are deflectable relative to the base portion 23 toward or away from the axis X. The plurality of retaining arms 28 are connected to the same side of the base portion 23 and extend generally along the axis X in an undeflected state. The plurality of retaining arms 28 are evenly arranged around the axis X. In the embodiment shown in the figures, the number of retaining arms 28 is twelve. In other embodiments, more or fewer retaining arms 28 can be provided.

The retaining arm 28 is connected at its proximal end to the base portion 23 and includes a locking head 281 at its distal end. The locking head 281 is used to engage with the first locking portion 31 and the second locking portion 32 on the insert 3. In the illustrated embodiment, the locking head 281 is formed in a claw shape. In other embodiments, the locking head 281 can have other shapes. The inner surface of the retaining arm 28 near the locking head 281 forms a driven surface 285. The driven surface 285 extends obliquely toward the axis X in the first direction D1.

The retaining member 2 further includes a first blocking portion 25. The first blocking portion 25 is connected to the base portion 23 and is arranged on the outer side of the base portion 23. It is used to restrict movement of the retaining member 2 relative to the part 40 in the first direction D1 after the connecting assembly 100 is inserted into the hole 405 of the part 40 (as shown in FIGS. 11A-11C). The first blocking portion 25 extends around the base portion 23 or extends outward from the base portion 23.

The retaining member 2 further includes a first sealing portion 26 and a second sealing portion 27. The first sealing portion 26 is at least partially located on a side of the first blocking portion 25 facing the retaining arms 28. It is connected to the first blocking portion 25 and extends circumferentially to form a ring. The second sealing portion 27 is at least partially located on a side of the first blocking portion 25 facing away from the retaining arms 28. It is connected to the first blocking portion 25 and extends circumferentially to form a ring. In some embodiments, the first sealing portion 26 and the second sealing portion 27 are integrally injection molded with the first blocking portion 25, respectively.

The retaining member 2 further includes isolation portions 29. The isolation portions 29 are arranged on the outer surfaces of the retaining arms 28 facing away from the axis X. The insert 3 and the retaining member 2 are made of a first material, and the isolation portions 29 are made of a second material. The elastic modulus of the first material is greater than that of the second material. Therefore, the isolation portions 29 are more elastic than the retaining member 2. In some embodiments, the first material is plastic, and the second material is rubber. In other embodiments, the second material can be silicone rubber, natural rubber, synthetic rubber, or other elastic materials. The isolation portions 29 are used to isolate the retaining arms 28 from the edge of the hole 405 of the part 40 (see FIGS. 11A-11C) so that the retaining arms 28 are not damaged by the edge of the hole.

In the illustrated embodiment, there are twelve retaining arms 28, which are equally divided into four groups. The isolation portions 29 on the retaining arms 28 of each group are formed integrally. Since the isolation portions 29 are more elastic than the retaining arms 28, this arrangement increases the retaining force of the retaining arms 28 without affecting their elasticity. In other embodiments, the isolation portions 29 on each retaining arm 28 can be provided independently of each other.

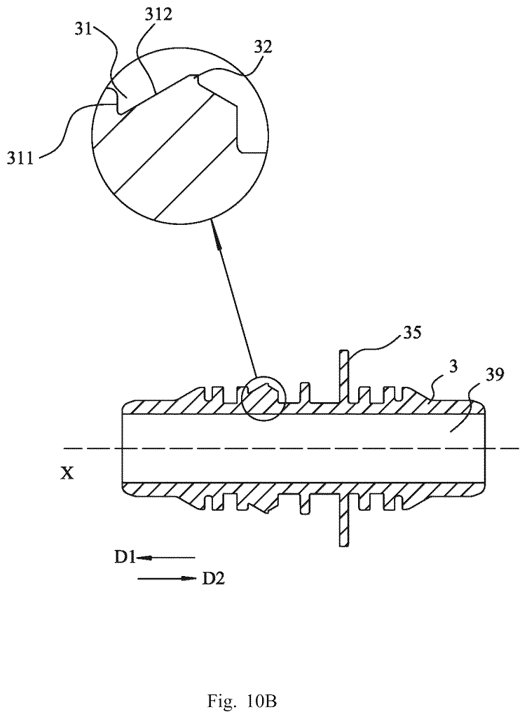

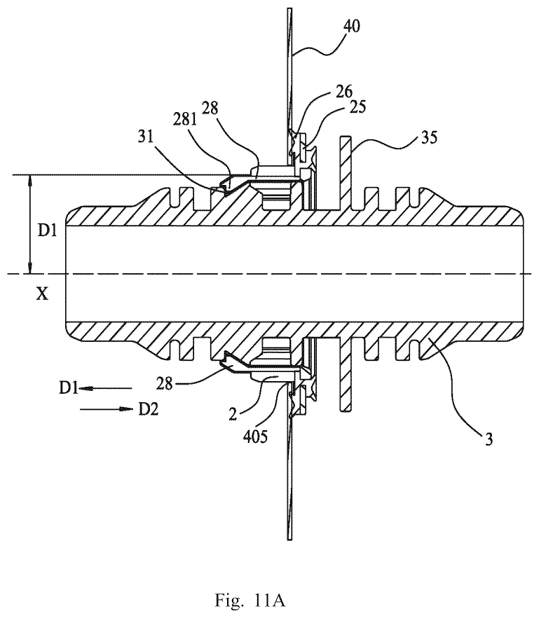

FIGS. 10A and 10B are a perspective view and an axial cross-sectional view of the insert 3, respectively. As shown in FIGS. 10A and 10B, the axial passage 39 of the insert 3 extends axially through the insert 3. The insert 3 is provided with a first locking portion 31 and a second locking portion 32 located at different axial positions on it.

The first locking portion 31 includes a first locking groove. In the illustrated embodiment, the first locking groove extends continuously around the axis X. In other embodiments, a plurality of spaced first locking grooves can be provided, the number of which is the same as the number of the retaining arms 28. The first locking groove is for receiving the locking heads 281 of the retaining arms 28. The first locking groove includes a first front side wall 311 and a first rear side wall 312. The first front side wall 311 extends substantially perpendicular to the axis X. The first rear side wall 312 extends obliquely away from the axis X in the second direction D2. Thus, when the locking head 281 is received in the first locking groove, the first front side wall 311 restricts movement of the insert 3 relative to the retaining member 2 in the second direction D2, and the first rear side wall 312 can also restrict, to some extent, movement of the insert 3 relative to the retaining member 2 in the first direction D1. Furthermore, the first rear side wall 312 drives the retaining arms 28 to deflect away from the axis X during the process of switching the connecting assembly from the pre-assembled state to the assembled state.

The second locking portion 32 includes a second locking projection. In the illustrated embodiment, the second locking projection extends continuously around the axis X. In other embodiments, a plurality of spaced second locking projections can be provided, the number of which is the same as the number of the retaining arms 28. The second locking projection is for cooperating with the locking head 281 to restrict movement of the insert 3 relative to the retaining member 2 in the second direction D2 when the connecting assembly is in the assembled state.

The insert 3 further includes a second blocking portion 35 on its outer surface. The second blocking portion 35 is used to restrict the connecting assembly 100 from moving relative to its installation position in the first direction D1 when the connecting assembly 100 is in the assembled state. In some embodiments, the second blocking portion 35 extends around the insert 3 to form an annular plate shape.

FIGS. 11A-11C show the cooperation between the retaining member 2 and the insert 3 when the connecting assembly 100 is in the pre-assembled state, in the assembled state, and during the installation process switching from the pre-assembled state to the assembled state. In FIG. 11A, the connecting assembly 100 is in the pre-assembled state and has already been partially pushed or pressed into the hole 405 of the part 40. In FIG. 11C, the connecting assembly 100 is in the assembled state. In FIG. 11B, the connecting assembly 100 is in the installation process of switching from the pre-assembled state to the assembled state.

As shown in FIG. 11A, when the connecting assembly 100 is in the pre-assembled state, the insert 3 is received by the retaining member 2. The retaining arms 28 of the retaining member 2 engage with the first locking portion 31 of the insert 3 via their locking heads 281. Thus, the insert 3 is restricted by the retaining member 2 from moving in the first direction D1 and the second direction D2. In the pre-assembled state, the farthest distance from the outer surface of the retaining arm 28 of the retaining member 2 to the axis X is D1. The farthest distance D1 is smaller than the radius of the hole 405 on the part 40, allowing the insert 3 and the retaining member 2 in the pre-assembled state to be inserted together into the hole 405 of the part 40. During the process of inserting the connecting assembly 100 into the hole 405 of the part 40, the retaining arms 28 of the retaining member 2 can guide the connecting assembly 100 to be centrally inserted into the hole 405. As shown in FIG. 11A, the retaining member 2 has already been inserted in place in the hole 405 of the part 40, and the first blocking portion 25 of the retaining member 2 abuts the rear side of the part 40 via the first sealing member 26. Therefore, the retaining member 2 is restricted from moving in the first direction D1.

As shown in FIG. 11B, when a pushing force or pressing force in the first direction D1 is applied to the insert 3 of the connecting assembly 100 in the pre-assembled state as shown in FIG. 11A, the first rear side wall 312 of the first locking portion 31 of the insert 3 cooperates with the driven surfaces 285 of the retaining arms 28 to drive the retaining arms 28 to deflect away from the axis X, causing the locking heads 281 of the retaining arms 28 to separate from the first locking portion 31. Thus, the insert 3 is released from the retaining member 2. The insert 3 moves relative to the retaining member 2 in the first direction D1 under the pushing force, enabling the connecting assembly 100 to be switched to the assembled state shown in FIG. 11C.

As shown in FIG. 11C, when the connecting assembly 100 is in the assembled state, it is installed in place in the hole 405 of the part 40 and is retained at its installation position. The retaining arms 28 are deflected away from the axis X. The locking heads 281 of the retaining arms 28 engage with the second locking portion 32 of the insert 3 to restrict movement of the insert 3 relative to the retaining member 2 in the second direction D2. The second blocking portion 35 of the insert 3 abuts the second sealing portion 27 on the rear side of the first blocking portion 25 of the retaining member 2 to restrict movement of the insert 3 relative to the part 40 in the first direction D1. In the assembled state, the farthest distance from the outer surface of the retaining arm 28 of the retaining member 2 to the axis X is D2. The farthest distance D2 is greater than the radius of the hole 405 on the part 40, so the deflected retaining arms 28 prevent the insert 3 and the retaining member 2 from being pulled out of the hole 405 in the second direction D2. The isolation portions 29 are always located between the retaining arms 28 and the edge of the hole 405, preventing the retaining arms 28 from being damaged by the edge of the hole 405.

The connecting assembly of the present disclosure, by providing a retaining member and an insert and enabling the insert to move relative to the retaining member along the axis to switch the connecting assembly from the pre-assembled state to the assembled state, allows an operator to connect the connecting assembly to a part by pressing the insert twice. The first press can insert the retaining member and the insert in the pre-assembled state together into the hole of the part and position the retaining member in place in the hole. The second press can cause the insert in the pre-assembled state to move relative to the retaining member positioned in the hole in the insertion direction (i.e., the axial direction), thereby changing the engagement position between the retaining member and the insert. Therefore, the installation process of the connecting assembly of the present disclosure to a part is simple to operate and does not require additional installation tools, making it particularly suitable for operations in narrow spaces or with obstructed vision.

While the present disclosure has been described in conjunction with the examples of embodiments outlined above, various alternatives, modifications, variations, improvements and/or substantial equivalents, whether known or that are or may be presently foreseen, may become apparent to those having at least ordinary skill in the art. The technical effects and technical problems in the specification are exemplary and are not limiting. It should be noted that the embodiments described in the specification may have other technical effects and can solve other technical problems. Accordingly, the examples of embodiments of the present disclosure, as set forth above, are intended to be illustrative, not limiting. Various changes may be made without departing from the spirit or scope of the invention. Therefore, the present disclosure is intended to embrace all known or earlier developed alternatives, modifications, variations, improvements and/or substantial equivalents.

### REFERENCE NUMBERS

10/100 Connecting Assembly
2 Retaining Member
21 First Retaining Arm
211 First Locking Head
22 Second Retaining Arm
221 Second Locking Head
223 Arm Body
224 Wedge Portion
2241 Inner Surface
225 Third Locking Portion
23 Base Portion
235 Receiving Passage
24 Guiding Arm
25 First Blocking Portion
3 Insert
31 First Locking Portion
311 First Front Side Wall
312 First Rear Side Wall
32 Second Locking Portion
321 Second Front Side Wall
322 Second Rear Side Wall
35 Second Blocking Portion
38 Sealing Portion
39 Passage
28 Retaining Arm
281 Locking Head
285 Driven Surface
26 First Sealing Portion
27 Second Sealing Portion
29 Isolation Portion

What is claimed is:

1. A connecting assembly, the connecting assembly having an axis and comprising:
a retaining member comprising a base portion and a plurality of retaining arms, the base portion defining a receiving passage, the plurality of retaining arms being connected to the base portion and deflectable relative to the base portion toward or away from the axis; and
an insert provided with a first locking portion and a second locking portion,
wherein the insert is received in the receiving passage of the retaining member and is movable relative to the retaining member along the axis in a first direction to switch the connecting assembly from a pre-assembled state to an assembled state, and
wherein at least one of the plurality of retaining arms is configured to engage with the first locking portion when the connecting assembly is in the pre-assembled state, and at least one of the plurality of retaining arms is configured to engage with the second locking portion when the connecting assembly is in the assembled state.

2. The connecting assembly according to claim 1, wherein the plurality of retaining arms comprise at least one first retaining arm and at least one second retaining arm;
wherein the at least one first retaining arm is configured to engage with the first locking portion when the connecting assembly is in the pre-assembled state, and to be driven by the insert during switching of the connecting assembly from the pre-assembled state to the assembled state to deflect away from the axis so as to disengage from the first locking portion; and
wherein the at least one second retaining arm is configured to engage with the second locking portion when the insert is in the assembled state.

3. The connecting assembly according to claim 2, wherein the first locking portion comprises at least one first locking groove, and the first retaining arm comprises a first locking head at a distal end thereof; and
wherein the first locking groove is configured to at least partially receive the first locking head and restrict movement of the insert relative to the retaining member in the first direction and a second direction opposite to the first direction.

4. The connecting assembly according to claim 3, wherein the first locking groove comprises a first rear side wall, and a portion of the first rear side wall that is farther from the axis extends obliquely away from the axis in the second direction; and
wherein the first rear side wall is configured to drive the first retaining arm to deflect away from the axis during switching of the connecting assembly from the pre-assembled state to the assembled state.

5. The connecting assembly according to claim 2, wherein the second locking portion comprises at least one second locking groove, and the second retaining arm comprises a second locking head at a distal end thereof; and
wherein the second locking portion is configured to cooperate with the second locking head to restrict movement of the insert relative to the retaining member in a second direction opposite to the first direction when the connecting assembly is in the assembled state.

6. The connecting assembly according to claim 5, wherein the second retaining arm further comprises a third locking portion provided on an outer side thereof facing away from the axis, the third locking portion being a locking protrusion; and
wherein the third locking portion is configured to restrict the connecting assembly from moving away from its installation position in the second direction when the connecting assembly is in the assembled state.

7. The connecting assembly according to claim 6, wherein the second retaining arm comprises an arm body and a wedge portion connected to the arm body, an outer surface of the wedge portion protruding outward relative to an outer surface of the arm body to form the third locking portion, and a distal end of the wedge portion forming the second locking head; and
wherein, in an undeflected state of the second retaining arm, the arm body extends substantially parallel to the axis, and an inner surface of the wedge portion extends obliquely toward the axis in the first direction.

8. The connecting assembly according to claim 5, wherein the retaining member is further provided with a first blocking portion connected to the base portion and configured to restrict movement of the retaining member relative to its installation position in the first direction; and
wherein the insert is further provided with a second blocking portion configured to restrict the connecting assembly from moving relative to its installation position in the first direction when the connecting assembly is in the assembled state.

9. The connecting assembly according to claim 8, wherein the insert is further provided with a sealing portion, the sealing portion being at least partially located on a side of the second blocking portion facing the first locking portion and the second locking portion, connected to the second blocking portion, and extending circumferentially.

10. The connecting assembly according to claim 2, wherein the retaining member further comprises a plurality of guiding arms connected to the base portion and uniformly arranged around the axis; and
wherein the plurality of guiding arms are configured to guide the connecting assembly in the pre-assembled state to be inserted into its installation position.

11. The connecting assembly according to claim 1, wherein each of the retaining arms is configured to engage with the first locking portion when the connecting assembly is in the pre-assembled state, to be driven by the insert during switching of the connecting assembly from the pre-assembled state to the assembled state to deflect away from the axis so as to disengage from the first locking portion, and to engage with the second locking portion when the connecting assembly is in the assembled state.

12. The connecting assembly according to claim 11, wherein the retaining arm comprises a locking head at a distal end thereof, wherein the retaining arm engages with the first locking portion or the second locking portion via the locking head.

13. The connecting assembly according to claim 12, wherein the first locking portion comprises a first locking groove; and
wherein the first locking groove is configured to at least partially receive the locking head to restrict movement of the insert relative to the retaining member in the first direction and a second direction opposite to the first direction.

14. The connecting assembly according to claim 13, wherein the first locking groove comprises a first rear side wall, the first rear side wall extending obliquely away from the axis in the second direction;
wherein the first rear side wall is configured to drive the retaining arm to deflect away from the axis during switching of the connecting assembly from the pre-assembled state to the assembled state.

15. The connecting assembly according to claim 14, wherein an inner surface of the retaining arm near the locking head forms a driven surface, and the driven surface extends obliquely toward the axis in the first direction so as to be driven by the first rear side wall.

16. The connecting assembly according to claim 12, wherein the second locking portion comprises a second locking projection; and
wherein the second locking portion is configured to cooperate with the locking head to restrict movement of the insert relative to the retaining member in a second direction opposite to the first direction when the connecting assembly is in the assembled state.

17. The connecting assembly according to claim 11, wherein when the connecting assembly is in the assembled state, the retaining arms are deflected away from the axis, so that the retaining arms restrict the connecting assembly from moving away from its installation position in a second direction opposite to the first direction.

18. The connecting assembly according to claim 11, wherein the retaining member is further provided with a first blocking portion connected to the base portion and configured to restrict movement of the retaining member relative to its installation position in the first direction; and
wherein the insert is further provided with a second blocking portion configured to restrict the connecting assembly from moving relative to its installation position in the first direction when the connecting assembly is in the assembled state.

19. The connecting assembly according to claim 18, wherein the retaining member further comprises:
a first sealing portion at least partially located on a side of the first blocking portion facing the retaining arms, connected to the first blocking portion, and extending circumferentially; and
a second sealing portion at least partially located on a side of the first blocking portion facing away from the retaining arms, connected to the first blocking portion, and extending circumferentially.

20. The connecting assembly according to claim 11, wherein the retaining member further comprises isolation portions disposed on outer surfaces of the retaining arms facing away from the axis;
wherein the insert and the retaining member are made of a first material, the isolation portions are made of a second material, and an elastic modulus of the first material is greater than an elastic modulus of the second material.
